(19) United States
(12) Patent Application Publication
(10) Pub. No.: US 2003/0221629 A1
(43) Pub. Date: Dec. 4, 2003

(54) Interactive artificial aquatic animal feeding device and method

(75) Inventors: David W. Cole, Salt Lake City, UT (US); Thomas K. Testa, Stansbury Park, UT (US)

Correspondence Address: Garron M. Hobson, THORPE NORTH & WESTERN, L.L.P., P.O. Box 1219, Sandy, UT, 84091-1219, US

(73) Assignee: Salt Creek, Inc.

(21) Appl. No.: 10/397,973

(22) Filed: Mar. 25, 2003

Related U.S. Application Data
(60) Provisional application No. 60/366,990, filed on Mar. 25, 2002.

(51) Int. Cl. A01K 61/02

(52) U.S. Cl. 119/51.04

(57) ABSTRACT

An interactive aquatic animal feeding method and device includes an elongated lead secured to a body with non-living edible material. The body can have characteristics to aid in the attraction of a feeding response from the aquatic animal, such as movement, shape, scent, coloring, flavoring, and texture. Movement may be facilitated by use of a flexible, resilient and/or elastic elongated lead. The body can be manipulated and moved in an aquarium. One or more devices can be packaged in a shell with a plurality of cavities to receive the bodies, and slits formed in walls surrounding the cavities to receive and bind the elongated leads. A series of channels adjacent to the walls or a single channel formed around the wall can be used to secure and store excess length of the elongated leads.

This application claims the benefit of U.S. Provisional Patent Application No. 60/366,990, filed Mar. 25, 2002.

### BACKGROUND OF THE INVENTION

1. Field of the Invention

The present invention relates generally to feeding captive aquatic animals. More particularly, the present invention relates to an interactive, non-living, aquatic animal feeding device and method.

2. Related Art

Hobbyists, researchers, zookeepers, and other aquarists require some means of effectively and safely feeding aquatic animals they keep in captivity. Such animals are often kept in aquariums of various sizes and shapes that allow the animals to be viewed and displayed. A vast array of these aquatic animals exists, each having diverse nutritional needs and feeding habits. In order to enable these individuals to properly care for this multitude of aquatic animals, they must have an effective means to feed them.

The primary means currently utilized to feed these animals include fish flakes of preserved food matter, frozen shrimp or krill formulations, and live feeder fish. The type or means of feeding these animals depends upon the specific needs of the feeding aquatic animal.

Fish flakes typically can be stored for long periods of time without any refrigeration. In addition, the manufacturer can adjust the nutritional components of the flakes to target different species of aquatic animals. Such flakes, however, typically only successfully feed top-feeders, and uneaten flakes often sink to the bottom of the aquarium and decompose, causing biochemical hazards for the aquatic animals.

Frozen shrimp, krill, and other non-processed formulations typically have the benefit of attracting many scavenging bottom feeders and many invertebrates that do not eat fish flakes. Because shrimp and krill are the actual food of some aquatic animals, acceptance by those aquatic animals is greatly improved due to the genuine texture, appearance, and scent of the shrimp and krill. Frozen shrimp and krill formulations, however, typically have a shorter shelf life than fish flakes and usually require refrigeration. Unlike fish flakes, the quality and nutritional value of this natural food source can be difficult to control.

Neither fish flakes nor frozen shrimp formulations are capable of feeding non-scavenging aquatic animals that require some sort of engagement from their prey. Such animals are often fed with live feeder fish, such as feeder goldfish, minnows, guppies, and other smaller fish. Live feeder fish can provide the necessary attack stimulus for most aquatic animals, and can have genuine characteristics, as they are the actual prey of many species.

Using live feeder fish, however, presents many problems. Most significantly is the cost and inconvenience associated with keeping and obtaining live feeder fish. Consumers must either frequent a live feed store or maintain a separate tank just to store the live feeder fish. Stores that provide live feeder fish are generally only located in metropolitan areas, and even at that they are not very prevalent. Maintaining a separate aquarium is expensive and can require a tank, aeration, heater, and a biological filter. In addition, a significant amount of time is involved to care for an aquarium including water testing, water changes, and feeding. This additional cost accumulates because live feed stores also have to maintain separate tanks for the live feeder fish. Furthermore, consumers often require certain live feeder fish to feed their particular aquatic species, and due to the plethora of aquatic species which require various live feeder fish, a consumer's ability to keep certain species is severely limited by the impracticality of stores making the expansive number of desired feeder fish available.

Another significant disadvantage of feeding with live feeder fish is the danger of introducing diseases and pathogens to the aquarium. Whenever living fish are added to an aquarium, there is a significant risk that the fish could have a contagious disease or pathogen that may infect the other aquatic animals. Introduced diseases can have a devastating impact on an aquarium, possibly killing all of the aquatic animals. As a preventative, many consumers maintain quarantine systems to ensure that new species are free of disease before adding new animals to their aquariums, albeit at a great cost.

### SUMMARY OF THE INVENTION

It has been recognized that it would be advantageous to develop a device and method for effectively and safely feeding various types of aquatic animals, including those requiring some engagement from their prey. In addition, it has been recognized that it would be advantageous to develop a device and method for allowing interaction between the aquatic animals and the feeder.

The invention provides a device and method for interactively feeding (and/or medicating) aquatic animals using a body with non-living edible material that is secured to an elongated lead that can be held by a user. The body can be disposed in an aquarium and manipulated by the user.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a perspective view of an aquatic animal feeding device in accordance with an embodiment of the present invention;

FIG. 2 is a perspective view of another aquatic animal feeding device in accordance with another embodiment of the present invention;

FIG. 3 is a schematic view of a method of feeding an aquatic animal with the device of either FIG. 1 or 2;

FIG. 4 is a perspective view of a package for the aquatic animal feeding device in accordance with an embodiment of the present invention; and

FIG. 5 is a partial perspective view of the package of FIG. 4.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

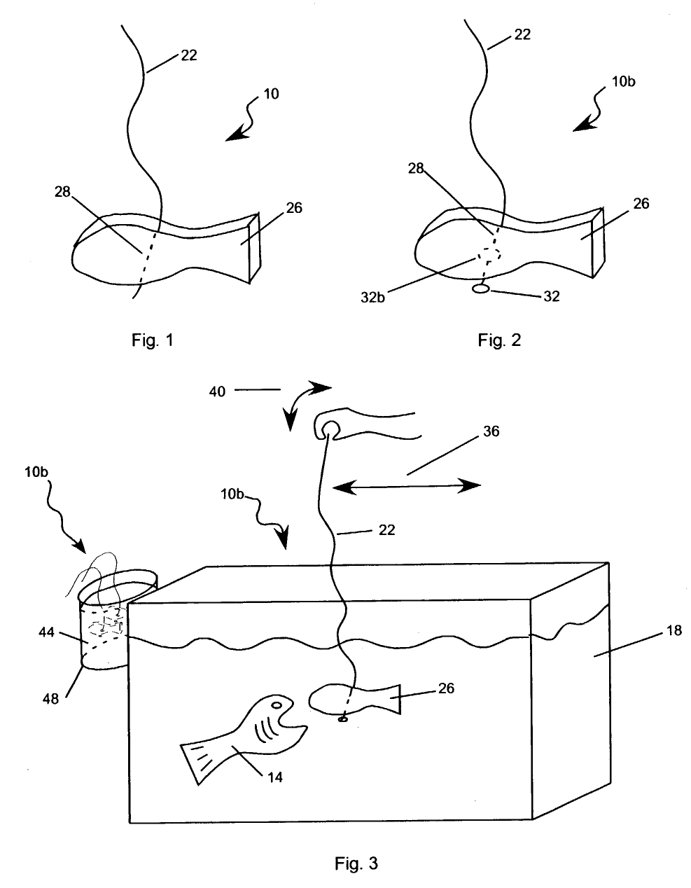

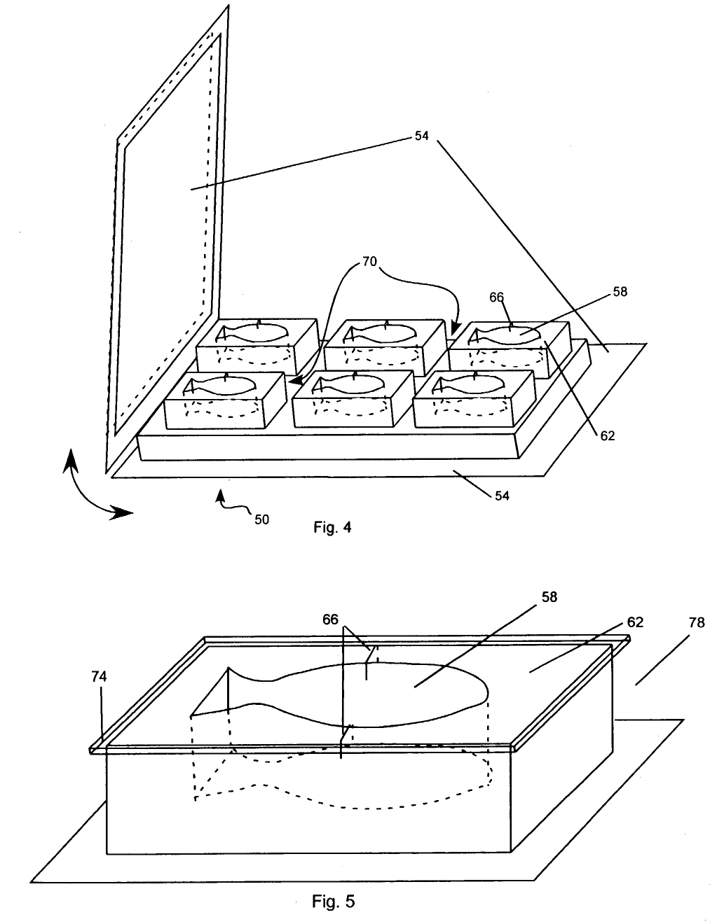

As shown in FIG. 1, an aquatic animal feeding device, indicated generally at 10, in accordance with an embodiment of the present invention is shown for feeding a captive aquatic animal 14 (FIG. 3). The captive aquatic animal 14 (FIG. 3) can include various breeds or species of fish, other aquatic vertebrates, invertebrates, etc. In addition, the captive aquatic animal 14 (FIG. 3) can be captive by, or contained by, an aquarium 18 (FIG. 3) or the like. As used herein, the term aquarium refers to aquariums, fish tanks, tanks, fish bowls, backyard ponds or pools, and similar enclosures used for keeping aquatic animals captive.

The device 10 includes an elongated lead 22 and a body 26 secured directly to a distal end of the elongated lead. The body 26 can include a bore 28 in which the lead 22 is disposed. The body 26 includes a non-living edible material for the aquatic animal 14 (FIG. 3). In one aspect, the body 26 itself can be formed by the edible material.

The elongated lead 22 can include a monofilament line. However, any device can be used that provides an elongated lead attached to the body 26. In one aspect, the elongated lead 22 can be flexible, resilient, and/or elastic. A flexible lead can allow the body to move. A resilient and elastic lead can form a spring, or spring-like member, and can impart an oscillating and/or sporadic movement to the body. Such a lead can help give the body fluid movements through the water. The elongated lead can be any length and can be adjusted based on the size of the aquarium 18.

In one aspect, the body 26 or edible material can include a mixture of water, Gelatin, and a composition of non-living edible materials, such as fishmeal, vitamins, oils, and/or minerals. The Gelatin can allow the edible material to be formed into a desired shape, and can also bind the various materials together. In another aspect, the body 26 or edible material can include medication, probiotics, and/or imunostimulants. The edible material can include any material or substance used for the sake of providing nutrition, inedication, probiotics, or imunostimulants. In addition, the edible material can include fillers, colorants, flavors, scents, etc. The use of non-living edible materials allows the invention to be stored for long periods. Preservatives can be added to allow storage without refrigeration. In addition, the edible materials can be adjusted in order to target the nutritional requirements of different species. The food can be bound together in the body 26 so that the uneaten portion does not fall to the bottom of the aquarium 18. Thus, the remaining portion can be reused, preventing waste and the decomposition of uneaten food that leads to biochemical hazards. The body 26 can also consist of dry formulations known in the art that are designed to slowly feed aquatic animals 14 over an extended period of time. With such a dry formulation, the body 26 can provide food to an aquarium 18 over several days by being placed in the aquarium 18 so that the aquatic animals 14 can slowly peck at the body 26.

The composition of the body 26 can be adjusted by varying components of differing buoyancies to obtain a desired buoyancy of the body 26. Appropriate buoyancies help the body 26 obtain fluid movements through the water. For example, bodies 26 with greater buoyancy would merely float, and bodies 26 with less buoyancy would sink quickly and merely hang on the lead 22.

A mixture of edible materials, Gelatin, and heated water can be poured into a mold which has the elongated lead 22 positioned in the mold so that the cooling mixture surrounds the end of the elongated lead 22. The cavity 58 (FIGS. 4 and 5) of the package 50 (FIG. 4), described below, can serve as the mold. This can reduce packaging expenses since the bodies 26 are formed directly in the packaging 50. In addition, the packages 50 can be reused. After cooling, the Gelatin swells and the elongated lead 22 is directly secured to the body 26 by a force of friction. Other embodiments of the body 26 may include binders in the edible material that act to hold the edible material together and/or secure it to the elongated lead 22.

In another aspect, the body can also include frozen formulations of shrimp, krill, or any other edible substance. The outer portions of a body 26 of these frozen formulations can slowly melt and break away from the body 26, simultaneously providing effective feeding for top, middle, and bottom feeding scavengers, invertebrates, and species that require engagement from their prey. The use of shrimp, krill, or other natural food formulations can aid the effective feeding of the aquatic animals 14. Shrimp and krill are actual prey for many species, therefore formulations of shrimp and krill have genuine characteristics of prey such as scent, appearance, and texture. For instance, shrimp and krill formulations can have a fleshy feel to them increasing acceptance by the aquatic animals 14. The body 26 can have an authentic characteristic of an authentic food source of the aquatic animal 14 to attract a feeding response from the aquatic animal 14. Authentic refers to any characteristic that attracts a feeding response in the aquatic animal 14. The body 26 can be shaped and/or sized to have a shape and/or size, and thus appearance, of an authentic food source. For example, the body 26 can be shaped as a fish, as shown. Other shapes and sizes, such as those giving the appearance of the prey of an aquatic animal 14 can also be used. Examples of possible shapes and sizes include, but are not limited to, the shapes and sizes of goldfish, guppies, worms, shrimps, and minnows. Shapes can also be designed to effectuate movement of the body 26 through the water. Shapes and sizes which provide authentic appearance and movement can aid in attracting a feeding response from the aquatic animals 14. Similarly, the body 26 or edible material also can include a texture of an authentic food source.

In addition, the body 26 or edible material can have a color or can be colored to include a color of an authentic food source. Coloring can be accomplished by the use of dyes included in the edible material, or applied to the body 26. The body 26 can include a color of the prey of the aquatic animal 14 to aid in attracting a feeding response. In another aspect, the body can be colored so that it catches the attention of the aquatic animal 14 (e.g. shiny silver).

In addition, the body 26 or edible material can include scent attractants or maskers, as known in the art, to attract aquatic animals 14. The scent can include a scent of an authentic food source. Examples include, but are not limited to, garlic oil, shrimp oil, menhaden oil, anise oil, amino acids, artificial and natural fish, seafood oils, or extracts of worms, planktons, fish, shrimp, squid, crabs, or artificial equivalents. In addition, the body 26 or edible material can also contain flavoring materials or a certain composition of ingredients providing a desired flavor of an authentic food source.

Referring to FIG. 2, another aquatic animal feeding device 10b in accordance with an embodiment of the present invention is shown which is similar in many respects to that described above. The device 10b can include an elongated lead 22 secured by disposing the elongated lead through a bore 28 in the body 26. In addition, the lead 22 can include an enlargement, such as a knot 32, at the end, as shown at 32, or within the body, as shown at 32b, in order to maintain the body 26 on the lead. The enlargement or knot 32 can be larger than the bore 28 so that the enlargement or knot 32 cannot pass through the bore. The knot 32 can be formed by tying the knot 32 in the lead. The body can be formed around the knot 32b by placing the lead through the slits 66 (FIG. 5) so that the knot 32b is centered within the cavity 58, and then pouring the non-living edible material into the cavity to mold the body 26 around the knot. The enlargement or knot 32 or 32b can provide extra resistance to prevent the body 26 from separating from the lead. This allows the body to be subjected to powerful strikes from an aquatic animal without separation from the lead. Furthermore, the body is secured to the lead without the use of a capturing device allowing safe and effective interactive feeding of the aquatic animal 14.

Referring to FIG. 3, a method of feeding aquatic animals 14 in an aquarium, and a method of using the devices described above, is shown. The user can hold or grip the elongated lead 22 at a proximate end opposite the body 26. The body 26 can be inserted into the aquarium 18 or the water containing the captive aquatic animal 14. As described above, the buoyancy of the body can be designed so that the body does not float on the surface, but sinks below the surface of the water. The user can manipulate the placement of the body 26 by displacing the lead 22, indicated by arrow 36. Thus, the user can selectively position the body 26 proximate the aquatic animal 14 by selectively positioning and manipulating 36 the lead 22 to displace or drag the body 26. A specific animal 14 can be targeted for feeding or enticed to come out into the open for observation. In addition, the user can manipulate other movement and/or acceleration of the body 26, indicated by arrow 40, to mimic movements of an authentic food source of the aquatic animal. Thus, in addition to looking, smelling and/or tasting like an authentic food source, the body 26 can also be made to act or move like the authentic food source. By emulating the movement of prey, the invention can stimulate a predatory response from an aquatic animal 14, and thereby effectuate the feeding of aquatic animals 14 that require some engagement from their prey without the costs and inconveniences associated with using live feeder fish. It will be appreciated that the feeding device 10 or 10b allows the user to go beyond mere observance of the aquatic animals to actually interacting with the aquatic animals by manipulating the placement and movement of the body. An example of such interaction includes “playing” with an aquatic animal 14 by attempting to entice a predatory response or maneuvering the body to avoid attack. Another example includes experiencing the feeling of an aquatic animal 14 striking at the body without capturing or causing harm to the aquatic animal.

Again referring to FIG. 3, a method of storing the body 26 in a liquid or gelatinous preservative 44 is shown. Liquid and gelatinous preservatives 44 known in the art can be used to store bodies consisting of non-preserved edible material without refrigeration. A container 48 of the liquid or gelatinous preservative 44 can be situated proximate to the aquarium 18 so that users can conveniently feed or interact with the aquatic animals 14. The use of a liquid or gelatinous preservative 44 for storage enables the body to include non-preserved feed such as formulations including shrimp and krill without the need for refrigeration.

Referring to FIG. 4, a plurality of devices 10 or 10b can be packaged in a package 50 that can maintain the form or shape of the bodies 26 (FIGS. 1 and 2), and can maintain or store the leads 22 (FIGS. 1 and 2). The package 50 can include a shell 54 or clamshell that can include a pair of halves pivotally coupled by a hinge or living hinge so that the halves can fold together to enclose the devices therein, and can fold apart to expose the devices. The shell 54 or halves can include a plurality of cavities 58, each partially or substantially surrounded by a perimeter wall 62. The cavities 58 can be sized and shaped to match the size and shape of the bodies 26 (FIGS. 1 and 2). Thus, the cavities 58 can help maintain the shape or form of the bodies, and/or resist contact between the bodies. A slit 66 can be formed through the wall 62 proximate each cavity 58 to receive and bind the leads 22 (FIGS. 1 and 2). An array or grid of channels 70 can be formed between the cavities 58 to store the excess length of the elongated leads. A ridge 74 can be formed around a portion of the perimeter wall 62 forming a channel 78 around the wall to store the elongated lead 22 (FIGS. 1 and 2). The lead 22 can be wound around the perimeter wall 62, and the end of the lead can be bound by inserting it through one of the slits 66 in the wall to prevent loosening of the lead.

It is to be understood that the above-referenced arrangements are illustrative of the application for the principles of the present invention. Numerous modifications and alternative arrangements can be devised without departing from the spirit and scope of the present invention while the present invention has been shown in the drawings and described above in connection with the exemplary embodiments(s) of the invention. It will be apparent to those of ordinary skill in the art that numerous modifications can be made without departing from the principles and concepts of the invention as set forth in the claims.

What is claimed is:

1. An interactive aquatic animal feeding device, comprising:
a) an elongated lead with opposite ends; and
b) a body, secured directly to one end of the elongated lead, including a non-living edible material for the aquatic animal.

2. A device in accordance with claim 1, wherein the body has a characteristic configured to attract a feeding response of the aquatic animal selected from a group consisting of:
a) a shape of an authentic food source of the aquatic animal;
b) a size of an authentic food source of the aquatic animal;
c) a scent of an authentic food source of the aquatic animal;
d) a coloring of an authentic food source of the aquatic animal;
e) a flavor of an authentic food source of the aquatic animal; and
f) a texture of an authentic food source of the aquatic animal.

3. A device in accordance with claim 1, wherein the elongated lead is flexible.

4. A device in accordance with claim 1, wherein the elongated lead is resilient and elastic.

5. A device in accordance with claim 1, wherein:
a) the body includes a bore through the body;
b) one end of the elongated lead is disposed through the bore; and
c) the elongated lead includes an enlargement at the end thereof which is larger than the bore.

6. A device in accordance with claim 1, wherein:
a) the body includes a bore through the body;
b) one end of the elongated lead is disposed through the bore; and
c) the elongated lead includes an enlargement within the body which is larger than the bore.

7. A device in accordance with claim 1, wherein the body is secured directly to the elongated lead by a force of friction.

8. A device in accordance with claim 1, wherein the body is secured to the elongated lead and includes a non-living edible material without a capturing device for the aquatic animal.

9. A device in accordance with claim 1, wherein the body includes a plurality of different materials having different buoyancies that together obtain a desired buoyancy of the body.

10. A devise in accordance with claim 1, wherein the body further includes a plurality of bodies disposed in a package comprising:
a) a shell;
b) a plurality of cavities, formed in the shell, each sized and shaped to receive one of the bodies therein;
c) a wall substantially surrounding each of the cavities; and
d) a slit, formed through each wall, sized to receive and bind the elongated lead line associated with the body.

11. A devise in accordance with claim 10, further comprising a plurality of elongated leads and a plurality of bodies disposed in a package comprising a series of channels with the elongated leads disposed therein.

12. A devise in accordance with claim 10, further comprising a ridge surrounding a portion of the wall forming the cavity and forming a channel around the wall to receive the elongated lead.

13. A method for feeding captive aquatic animals, comprising the steps of:
a) attaching a body to one end of an elongated lead, the body including a non-living edible material for aquatic animals;
b) inserting the body into water containing the captive aquatic animals; and
c) holding an opposite end of the elongated lead.

14. A method in accordance with claim 13, further comprising the step of manipulating the opposite end of the elongated lead, and thus placement and movement of the body in the water.

15. A method in accordance with claim 13, further comprising the step of adding scent attractants of the aquatic animals to the body.

16. A method in accordance with claim 13, further comprising the step of simulating characteristics that attract a feeding response of the aquatic animals, the simulating characteristics being selected from a group consisting of:
a) forming the body into a shape and size of an authentic food source of the aquatic animals;
b) coloring the body with a color of an authentic food source of the aquatic animals;
c) flavoring the non-living edible material of the body with a flavor of an authentic food source of the aquatic animals;
d) adding a scent to the body or the non-living edible material with a scent of an authentic food source of the aquatic animals; and
e) manipulating movement of the body with movements of an authentic food source of the aquatic animals.

17. A method in accordance with claim 13, further comprising the step of manipulating placement and movement of a body with a flexible elongated lead.

18. A method in accordance with claim 13, further comprising the step of manipulating placement and movement of the body with a resilient and elastic elongated lead.

19. A method in accordance with claim 13, further comprising the steps of:
a) forming a bore through the body;
b) disposing an end of the elongated lead through the bore; and
c) placing an enlargement which is larger than the bore near the end of the elongated lead disposed through the hole.

20. A method in accordance with claim 13, wherein the step of attaching a body to one end of an elongated lead further includes the step of securing the body directly to one end of the elongated lead.

21. A method in accordance with claim 13, wherein the step of attaching a body to one end of an elongated lead further includes the step of securing the body directly to the elongated lead by a force of friction.

22. A method in accordance with claim 13, further comprising the step of interactively feeding aquatic animals the non-living edible material of the body without capturing the aquatic animals.

23. A method in accordance with claim 13, further comprising the step of storing the body in a liquid or gelatinous preservative.

24. A method for feeding aquatic animals within an aquarium, comprising the steps of:
a) attaching a body to one end of an elongated lead, the body including a non-living edible material for aquatic animals;
b) inserting the body into the aquarium; and
c) holding an opposite end of the elongated lead and outside the aquarium.

25. A method in accordance with claim 21, further comprising the step of manipulating the opposite end of the elongated lead, and thus placement and movement of the body in the aquarium.
